(19) United States
(12) Patent Application Publication
(10) Pub. No.: US 2001/0035375 A1
(43) Pub. Date: Nov. 1, 2001

(54) Filter for arrayable micro-centrifuge

(76) Inventor: Scott P. Humicke-Smith, Menlo Park, CA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/872,788

(22) Filed: Jun. 1, 2001

Related U.S. Application Data
(63) Continuation of application No. 09/324,251, filed on Jun. 2, 1999, now abandoned.
(60) Provisional application No. 60/088,022, filed on Jun. 4, 1998.
(60) Provisional application No. 60/092,437, filed on Jul. 10, 1998.

(51) Int. Cl. B01D 63/16

(52) U.S. Cl. 210/321.68; 210/321.69; 210/506

(57) ABSTRACT

A new centrifuge filter is designed for use in an arrayable micro-centrifuge. The filter has an upstream end where fluid enters the filter, an opposite or downstream end, and sides where fluid exits by centrifugal force. The filter is a piece of semipermeable material which is capable of letting certain fluids and small molecules pass therethrough and retaining macromolecules and particles. Also disclosed is an optional support for the filter.

This application claims the benefit of U.S. Provisional Application No. 60/088,022, filed Jun. 4, 1998, and U.S. Provisional Application No. 60/092,437, filed Jul. 10, 1998.

### TECHNICAL FIELD

The present invention relates to a filter assembly for use in a modular, arrayable micro-centrifuge.

### BACKGROUND OF THE INVENTION

A filter assembly typically includes a housing which contains a filter unit comprising one or more filter elements in a cylindrical unit comprising one or more members. The filter units and the filter elements may have any of a variety of suitable configurations. While the cylindrical filter units are rotating, a process fluid is pumped into the unit from a process fluid inlet. Process fluid is centrifuged toward the wall of the centrifuge which causes the fluid to pass through the filter so that part of the process of fluid, i.e., the filtrate, passes through the filter elements. Fluid that exits the filter is the filtrate and it exits the housing through a filtrate outlet. The remainder of the process fluid, the retentate, can remain on the filter or can be washed out as a next step in an arrayable micro-centrifuge.

Current micro-centrifuge filters are available for processing small individual samples. One such filter is provided in three or more parts: a filter cup containing the membrane with cap attached, a collection tube for capturing the filtrate and a separate cap for the collection tube and filtrate. With this filter, the centrifugation/filtration process is very labor intensive. First, all the tubes are labeled. Then the cap is removed, the filter cup is filled with process fluid, the cap replaced and each tube placed in a conventional centrifuge. After the centrifugation cycle, each tube is removed and uncapped. The filter cup is removed and a clean cap placed on the collection tube.

Such disadvantages are even more important in the field of high-throughput laboratory work. Typically, high-throughput samples are retained and processed in a 96-well plate. The entire plate or multiple plates are placed in large centrifuges which require a large diameter to accommodate the rectangular plates. Such large centrifuges also take a long time to start up and slow down. Laboratory protocols for such large numbers of samples allocate a large amount of time for centrifugation. These centrifuges must be carefully balanced and usually require human intervention, although robotic arms are available. Unfortunately, robotic arms are very expensive and require a custom-designed centrifuge housing to accommodate their use.

An arrayable micro-centrifuge has recently been developed to permit the highly efficient analysis and processing of a large number of very small samples. This arrayable micro-centrifuge is described in PCT Publication No. ______ (U.S. patent application Ser. No. 09/176,701), assigned to Stanford University. It is novel in that rather than housing many sample containers and spinning these many containers about a single axis for centrifugation, this arrayable centrifuge has many built-in containers which rotate about their own axes. This transforms the centrifugation process from “load sample into container, then load container into centrifuge” into simply “load sample into centrifuge”.

Currently, there is no suitable filter for such an arrayable micro-centrifuge. Conventional centrifuges utilize filter means such as that described by U.S. Pat. No. 4,683,058, issued Jul. 28, 1987. In that invention, the centrifuge tubes are pre-loaded with a filter. The sample is then placed into the filter and the entire filter/tube assembly is placed into a centrifuge. The centrifugal force then acts in a direction largely axial relative to the centrifuge tube and filter. Thus, to be maximally effective, the filter must be perpendicular to the tube axis.

U.S. Pat. No. 5,647,990, is an interesting variant of the previous tube-based filter. In that invention, the filter is arranged parallel to the axis of the tube, but again it is necessary to first load the filter into the tube, the sample into the filter, and finally the filter/tube assembly into the centrifuge. While in this case the filter is parallel to the tube axis, the centrifugal force required still acts largely parallel to the filter. Besides the additional steps, this requires a longer filtration time relative to the present invention since the maximum centrifugal force is not directed through the filter.

In U.S. Pat. No. 5,679,249, a filter rotates about its own axis. The '249 patent discloses that the filter moves relative to adjacent members. Moreover, the '249 patent discloses process fluid flow parallel to the filter while the filter rotates about its own axis. The '249 patent discloses that an externally generated pressure differential must drive the process fluid through the filter.

There is a need for a filter, adapted for use in the arrayable micro-centrifuge. The filter must allow for high speeds and forces (5,000 to 100,000 revolutions per minute) and arrayable usage. Therefore, the filter must be strong to handle the high speed rotation about the filter's axis and also must be designed to let at least the filtrate and optionally the retentate flow through the centrifuge in a largely radial direction with respect to each container.

In the current invention, the filter is loaded directly into the arrayable centrifuge and the sample is loaded into the filter, (which rotates about its own axis). This filter allows for high-speed (5,000-100,000 revolutions per minute). It can be fabricated from different materials to accumulate or pass through a variety of substances that are found in process solutions. For example, a glass filter will collect single stranded DNA from a high salt solution through ionic interactions. Next the DNA retentate is eluted and washed out with a solution with lower salt content. During centrifugation, the centrifugal force acts in a largely radial direction relative to the filter. Consequently, to be maximally effective the filter should be parallel to the tube axis. The significant advantage of the present invention is the elimination of several tube loading and unloading steps necessary in the present technology. Moreover, since the filter in this case can be reused, the number of processing steps reduced even further relative to conventional tube and filter centrifugation methods.

### SUMMARY OF THE INVENTION

Herein is disclosed a filter for use in an arrayable micro-centrifuge. The filter has a filter element with an upstream end where fluid enters, an opposite or downstream end which may be open or closed, and sides through which fluid exits by centrifugal force. The filter element comprises at least a piece of semipermeable material, which is capable of letting certain fluids pass therethrough and retaining other substances.

Optionally, the filter element is substantially cylindrical or cone shaped.

In another embodiment, the filter element is supported at its upstream end with a rigid collar.

Optionally, the filter element has a retractable clip at the downstream end, said clip being closed during filtration and washing and retracted during flushing of the retained substances.

In another embodiment, the centrifuge filter material is a controlled pore-size membrane. Optionally, the centrifuge filter material has a molecular weight cutoff between about 3,000 and 100,000 daltons. In another embodiment, the centrifuge filter material may separate retentate from permeate based on molecular charge.

In yet another embodiment, the centrifuge filter material may separate retentate from permeate based on ionic interactions with the retentate or permeate In yet another embodiment, the centrifuge filter material is chemically derivatized so that the chemical species bound on the filter have a specific desired interaction with chemical species in the filtrate.

### BRIEF DESCRIPTION OF THE DRAWINGS

FIG. 1 is an exploded view of the filter system in a micro-centrifuge. It shows starting at the top, the filter, the filter support, the upper half of the micro-centrifuge with fluid inlet, and the lower half of the micro-centrifuge with an optional fluid outlet at the bottom.

FIG. 2 is a lateral cross-sectional view of the filter system inside the micro-centrifuge.

FIG. 3a is a lateral view of the filter assembly, and

FIG. 3b is a cross-sectional view of FIG. 3a at A, showing the filter and its support.

FIG. 4 shows a typical assembled micro-centrifuge ready to be inserted into the plate in which the micro-centrifuges are spun.

### DETAILED DESCRIPTION OF THE INVENTION

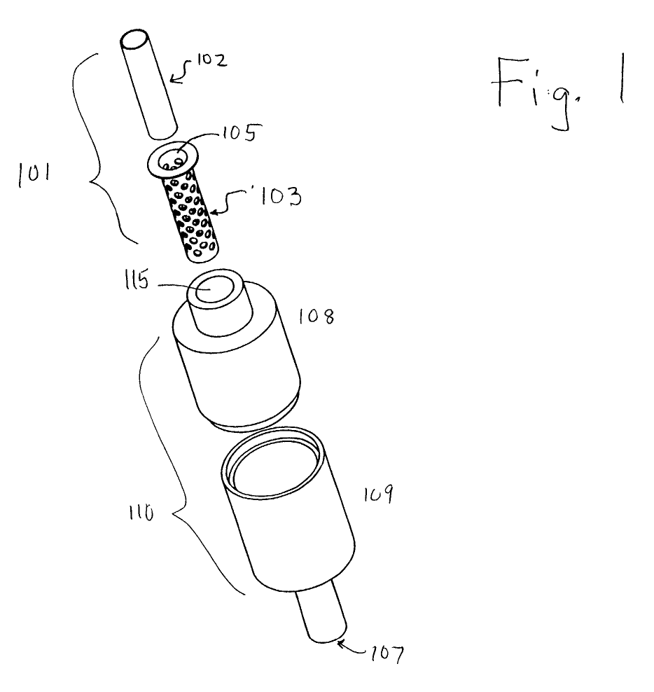

As shown in FIG. 1, the micro-centrifuge filter of the present invention consists of filter assembly 101. The filter unit preferably includes one or more stacked filter elements 102 supported by a holder 103. The filter elements may be constructed in a variety of ways. For example, the filter elements may be flat or have a generally conical shape. Further, the filter element includes a porous filter wherein the size and distribution of the pores of the filter may be selected in accordance with the requirements of any particular application. For example, the filter element may comprise a rigid porous material such as a porous metal element, a porous ceramic element, or a porous plastic element. An advantage of an embodiment having a rigid porous material is that the rigid porous filter layers can be attached only along the edge of the element and at the inner and outer diameters. A rigid porous layer can also obviate the need for a holder.

FIG. 1 also shows the micro-centrifuge 110. It shows fluid inlet 105 and optional outlet 107 and the upper half 108 and lower half 109 of the micro-centrifuge.

Note that if the outlet 107 does not exist, the permeate may be withdrawn if the holder and filter are open at the bottom to allow a tube to descend to the bottom of the micro-centrifuge and aspirate the fluid.

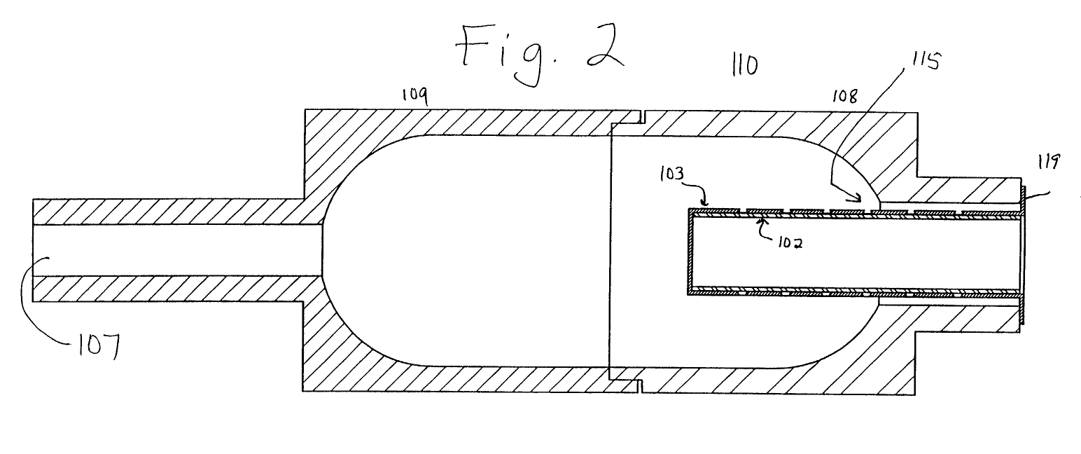

FIG. 2 is a lateral cross sectional view of the filter assembly in the assembled micro-centrifuge. It shows engagement of the filter and assembly at the micro-centrifuge fluid inlet 115. The filter support 103 has a collar 119 which helps keep the filter assembly in place. In another embodiment, there is provided a stiff filter material 102, to which a collar is attached directly. The scale of this figure is about 8:1 with an actual micro-centrifuge and filter assembly.

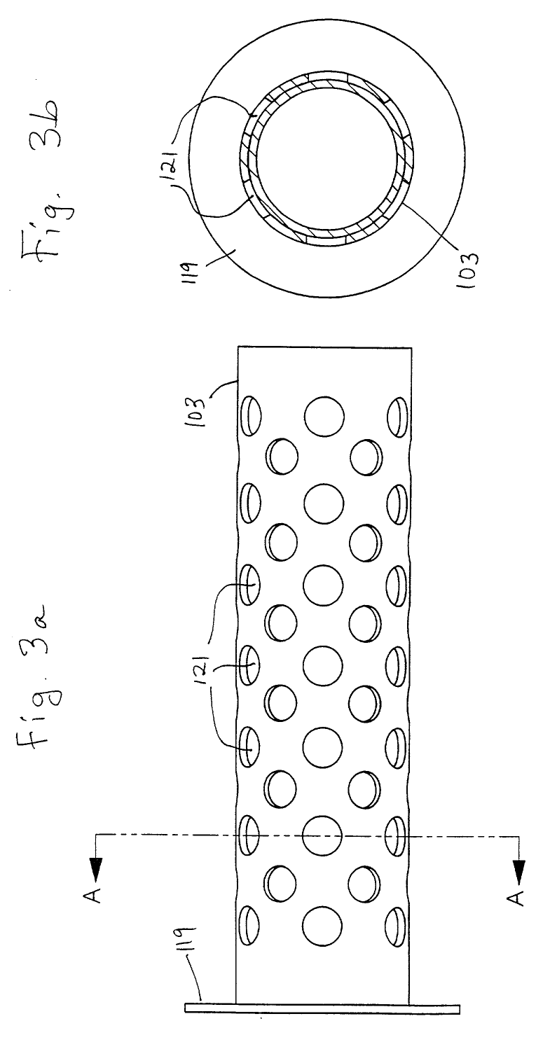

FIGS. 3a and 3b are other views of the filter assembly. FIG. 3a shows the surface of the filter assembly. FIG. 3b is a cross section of the filter assembly (side to side of the cylinder), consisting of filter material 102 and a solid support 103 with profiled holes 121. The approximate scale is 16:1.

The support may be cylindrical, as shown in FIG. 3, or may be of any other convenient axi-symmetric shape and is optional. The filter material 102 may be single- or multi-layered. The material can be stiff enough to operate without a support. Alternately, the material is soft and it may take on the interior shape of the proposed support(s).

The filter itself may require internal support. Thus, changing the composition of the filter may make it capable of both filtering and supporting.

The filter need not overlap entirely the support if the filter and support together are sufficient to prevent flow of filtrate. For example, there can be overlapping stripes of filter and support.

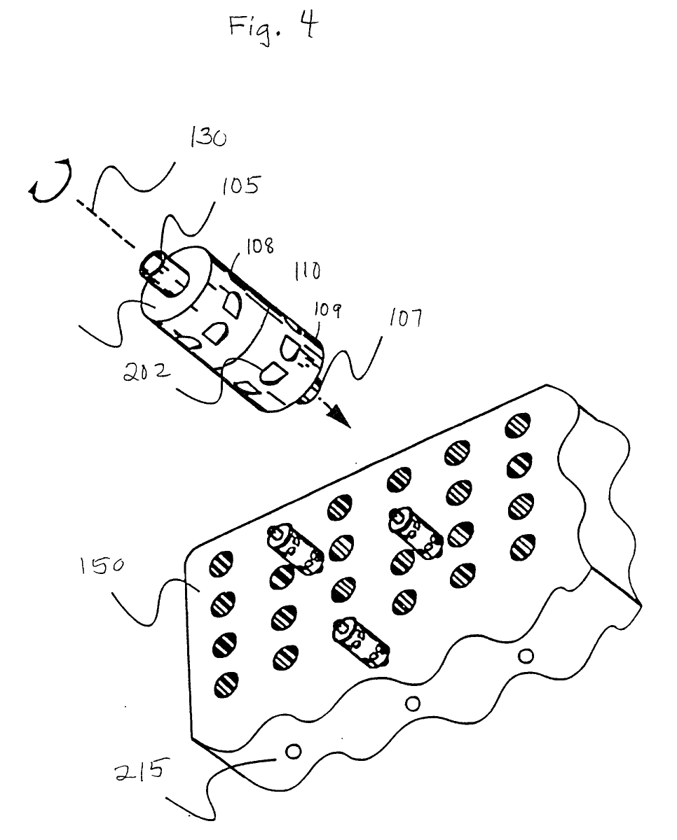

FIG. 4 also shows an assembled micro-centrifuge 110 (in this case, an array of micro-centrifuges), to be inserted into a manifold block 213. For rotation about the axis 130, air is delivered through the holes 215 in the manifold block 213 so that it strikes the cut-outs in the micro-centrifuge 202, causing the assembly to turn about the axis 130. The centrifuges optionally can be operated by other forms of energy, such as a mechanical belt or electromagnetism.

Some hard-to-filter solutions, such as serum, tissue culture media or other highly particulate solutions, including those containing lipids, triglycerides and lipoproteins can clog filters. These solutions can be pre-filtered in one filter membrane, for example with Polydisc or Polycap SPF Serum Prefilters which contain four layers of filter media, including fine and ultrafine glass microfiber and a layer of polysulfone (Catalog Nos. 6705 and 6724, Whatman Inc.). In addition, it may be helpful to prefilter salt solutions, virus suspensions, and reagent preparations with a disposable filtration system (e.g., Clyde® filtration system with polyethersulfone membrane, Whatman Inc.)

Because the filter and chamber are rotating, the process fluid is propelled radially outward toward and through the filter. Hence, centrifugal force is provided by which the process fluid is forced outward through the filter. As the process fluid progresses into the filter cylinder, it is separated into permeate which passes through the filter and retentate which is trapped in or on the filter. If the centrifugal forces are high enough, the permeate may collect on the wall of the centrifuge as long as it continues to run. If the centrifuge is stopped or slowed sufficiently, the permeate will drain down to the bottom of the micro-centrifuge under the influence of gravity. If an embodiment with a fluid outlet, the permeate may then simply flow out of the micro-centrifuge or the surface tension of the fluid may necessitate the application of air pressure above the liquid to drain. In embodiments without a fluid outlet, a tube or needle may be inserted through the center of the filter to aspirate the permeate.

The semipermeable membrane may comprise any polymeric material which is compatible with the process fluid. For example, the membrane may comprise a nylon, polyvinylidene difluoride, polyethersulphone, PTFE, or a combination thereof. Further the membrane may comprise a single layer or several layers and may include a woven or non-woven support such as a non-woven polypropylene. The size of the pores in a controlled pore-size porous polymeric membrane are selected to meet the requirements of the particular application.

Polyethersulfone (asymmetric mixed esters of cellulose) membrane has low protein binding (i.e., removal of cells and particulates, purification of proteins, enzymes, nucleic acids and virus suspensions) and no surfactants and is available in either 0.2 μm or 45 μm.

Cellulose acetate membrane is available in 0.2 μm, 0.45 μm, 0.65 μm and 5.0 μm for low protein binding applications, mentioned above. Polyvinylidene membrane in 0.2 μm and 0.34 μm is also suitable for the low protein binding, as well as clarification of acidic or basic samples and samples containing organic solvents.

MPS matrix is an inert polymeric microporous sheet that contains silica which is readily available for functionalizing with ion exchange groups or affinity ligands. MPS matrix is extremely porous (70-80%) and has a high surface area (80 m²/g). This promotes extremely fast binding and elution kinetics at rapid flow rates (2-15 ml/min) and low pressure drops (1-15 psi). The MPS matrix can be prepared for ion exchange with DEAE (purify enzymes, general proteins, some antibodies, bind acidic proteins), QUAT (remove contaminating DNA or endotoxins), PEI (purify proteins and remove DNA contaminant), CM and SP (bind basic proteins and some antibodies). The MPS matrix also can be prepared with Protein A (bind rabbit, human and some mouse antibodies from serum, ascites, or cell culture supernatant), Protein G (bind antibodies not binding well to protein A), glutaraldehyde (GTA) (customize for immuno affinity by binding either antibody or antigen), and amino activated (effective when GTA is not useful), hydrazide (bind antibody as the ligand), heparin (DNA binding proteins, special blood coagulation factors) and silica (bind plasmid DNA or remove DNA thereby recovering it from other proteins; instead of cesium chloride extraction or anionic exchange).

Ultrafiltration membranes are especially suited for use in the inventive filter. Ultrafiltration membranes separate the components in a mixture by size exclusion or sieving. The membranes are asymmetric (anisotropic) in structure with a narrow pore size distribution. They have a rejecting skin supported by a porous polymer layer which in turn is supported on a fabric backing. UF membranes perform separation only on the surface, in contrast to depth filters which separate throughout the entire thickness of the filter. Since UF membranes separate by size rather than molecular weight, factors which influence the size of the species in solution will affect performance. Some of these factors include solution temperature, pH, ionic strength, presence of other species in the mixture, etc. Not all macromolecules of the same molecular weight will assume the same solution “size”. For example, linear molecules generally exhibit a smaller size profile than globular ones. Other physical factors, such as stirring speed, filtration pressure and fouling of the membrane surface also influence performance. Thus, the different membranes are said to have a “nominal MW cutoff”. The membrane should be selected so that the MWCO is at least four ratings lower than the actual MW of the species being removed. For example, a 10,000 MWCO membrane should be used to remove species of >40,000 Dalton molecular weight. The closer the molecular weight of the species is to the MWCO rating of the membrane, the more break-through can occur.

The following table shows the molecular weight cutoff and the equivalent catalog numbers from Amicon and Whatman (data from Whatman Web site: Introduction to Ultrafiltration Filters).

| MW Cutoff (MWCO) | Amicon | Whatman |
|---|---|---|
| 10,000 | PM10 | 10K |
| 30,000 | PM30 | 30K |
| 50,000 | PM50 | 50K |
| 100,000 | XM100 | 100K |
| 300,000 | XM300 | 300K |
| 500,000 | ZM500 | 500K |

In addition to the choice of semipermeable material(s), the internal surface of the filter unit may have a microscopic surface roughness as well as gross surface structures, such as protrusions, recesses, or a combination of the two. For example, the inner filter walls may have ridges or grooves extending across the length of the cylinder or spirally within the filter. The surface structure of the disks is intended to produce several effects. For example, it facilitates and/or optimizes the formation of turbulent flow at the filter surface and the formation of small eddy currents, which more quickly spread out and expose the fluid sample to the filter.

Various support materials can be used. The support material may or may not have filtration capacity. Commonly used support materials include medical grade polypropylene, polystyrene, nylon, steel and polyphenylene sulfide available from Phillips Petroleum under the trade name Ryton. These support materials also may be reinforced with such substances as oriented glass fibers dispersed in the polymeric material or metal integrated into the material. This reinforcement provides additional structural integrity for the required strength. It also provides dimensional stability by resisting expansion of the cylindrical filter due to temperature or moisture absorption. The support material also may have through-holes and channels which allow the permeate to drain from the filter and pass to the fluid outlet of the micro-centrifuge. Preferred channels are shown in profile in FIG. 4, which is a cross-section of the micro-centrifuge with filter in place. The passages in the support plate may be contoured to minimize back pressure on the filter and balance transmembrane pressure.

Such a filter may be mounted on its support by any suitable manner, including heat-sealing, welding, or by means of a solvent or an adhesive.

The filter material may or may not provide high flow rate since the required flow rate varies depending on the application.

The volumes of the filter and micro-centrifuge are typically around 100 and 400 microliters, respectively. With no substantial changes in design, however, they could accommodate as little as 10 microliters each or as much as 2000 microliters each.

### EXAMPLE 1

This embodiment is a hollow cylinder whose outer diameter is less than the inner diameter of the micro-centrifuge. The hollow cylinder is fabricated so that there is a fluid inlet end and a closed end opposite the fluid inlet end. The walls of the cylinder comprise at least one layer of semipermeable material. Optionally, the outer surface of the cylinder may be a holder.

The fluid inlet end of the filter has a collar, which fits around the fluid inlet. The collar is fabricated from molded plastic which preferably contacts the rotating portion of the micro-centrifuge. According to one aspect of the construction, the collar has a keyhole opening which facilitates mounting the filter unit on a bayonet on the inner side of centrifuge wall. Alternately, the collar or fitting may be a simple press-fit into the fluid inlet end of the micro-centrifuge.

The semipermeable material of the walls is chosen for the experimenter's purpose (see above materials discussion).

In use, the hollow cylinder spins at the same rate as the micro-centrifuge. As the fluid enters the hollow cylinder, it is spun to the outer walls until it contacts the filter wall. At the filter wall, the retentate is retained on the surface or inside the filter, depending on the nature of the retentate and the filter. The filtrate passes to the fluid outlet of the micro-centrifuge as the rotation speed is slowed and the fluid moves to the outlet under the action of gravity. The sample is expelled from the micro-centrifuge by wash-out of air or solution, which cleanses the micro-centrifuge before the next sample enters. In a preferred embodiment, the filter may be left in the micro-centrifuge for multiple samples, the filtrate containing the desired entity(ies) to be measured downstream, and the retentate successively being retained in the hollow filter. This filter embodiment presents a very large filtration area. Initially, it is expected that retentate builds up in the portion closer to the fluid inlet. Then subsequent samples traverse more of the length of the filter before the filtrate can separate from the retentate.

### EXAMPLE 2

This embodiment is a solid filter cylinder in a holder. The holder has a collar which contacts the outer face of the fluid inlet of the centrifuge. When the holder is slipped into the micro-centrifuge inlet (screwed, mounted bayonet style, or in a lock and key configuration), the filter is capable of rotating with the micro-centrifuge. In this embodiment, the filter is made of a loose material packed together, through which the filtrate passes rapidly. A “solid” filter may be preferred because of the very great surface area of all the fibers contained therein. For example, a highly porous silica matrix is used as a solid cylinder to collect DNA from a sample. The matrix is contained in a supporting holder which may itself be a filter material or a solid cylindrical screen which can contain the matrix. After the filtrate is discarded, the next fluid to enter the chamber is a solubilizing fluid to remove the DNA and carry the DNA sample to the next parts of the apparatus for appropriate measurement or other manipulation.

### EXAMPLE 3

This embodiment is a hollow cylinder whose outer diameter is less than the inner diameter of the micro-centrifuge. The hollow cylinder is fabricated so that there is a fluid inlet end and a closed end opposite the fluid inlet end. The walls of the cylinder comprise at least one layer of semipermeable material. Optionally, the outer surface of the cylinder may be a holder.

The fluid inlet end of the filter has a collar, which fits around the fluid inlet. The collar is fabricated from molded plastic which preferably contacts the rotating portion of the micro-centrifuge. According to one aspect of the construction, the collar has a keyhole opening which facilitates mounting the filter unit on a bayonet on the inner side of centrifuge wall. Alternately, the collar or fitting may be a simple press-fit into the fluid inlet end of the micro-centrifuge.

The semipermeable material of the walls is chosen for the experimenter's purpose (see above materials discussion).

In use, the hollow cylinder spins at the same rate as the micro-centrifuge. As the fluid enters the hollow cylinder, it is spun to the outer walls until it contacts the filter wall before it exits the open bottom end. At the filter wall, the retentate is retained on the surface or inside the filter, depending on the nature of the retentate and the filter. The filtrate passes to the bottom of a closed-bottom micro-centrifuge as the rotation speed is slowed and the fluid moves to the outlet under the action of gravity. The sample is aspirated from the micro-centrifuge by an external tube or needle extended through the filter to the bottom of the micro-centrifuge. Once the tube or needle is in place, the sample is drawn into the tube or needle through an external driving force which applies suction to the sample, such as a syringe pump hydraulically connected to the tube or needle. In a preferred embodiment, the filter may be left in the micro-centrifuge for multiple samples, the filtrate containing the desired entity(ies) to be measured downstream, and the retentate successively being retained in the hollow filter. This filter embodiment presents a very large filtration area. Initially, it is expected that retentate builds up in the portion closer to the fluid inlet. Then subsequent samples traverse more of the length of the filter before the filtrate can separate from the retentate.

While the invention has been described in some detail by way of illustration, the invention is amenable to various modifications and alternative forms, and is not restricted to the specific embodiments set forth. These specific embodiments are not intended to limit the invention but, on the contrary, the intention is to cover all modifications, equivalents, and alternatives falling with in the spirit and scope of the invention.

What is claimed is:

1. A filter for use in an arrayable micro-centrifuge, the filter comprising a filter element having an upstream end where fluid enters, an opposite or downstream end, and sides through which fluid exits by centrifugal force;
the filter element comprising at least one piece of semipermeable material, the material being capable of letting certain fluids pass therethrough and retaining other substances.

2. The centrifuge filter of claim 1, wherein the filter element is substantially cylindrical in shape.

3. The centrifuge filter of claim 1, wherein the filter element is substantially cone shaped.

4. The centrifuge filter of claim 1, wherein the filter element is supported at the upstream end with a rigid collar.

5. The centrifuge filter of claim 1, wherein the downstream end of the filter element is open.

6. The centrifuge filter of claim 1, wherein the downstream end of the filter element is closed.

7. The centrifuge filter of claim 1, wherein the filter element is supported at the downstream end with a retractable clip, said clip being closed during filtration and washing and retracted during flushing of the retained substances.

8. The centrifuge filter of claim 1 wherein the material has a molecular weight cutoff between about 3,000 and 100,000 daltons.

9. The centrifuge filter of claim 1, wherein the semipermeable material is selected for its ability to separate retentate from permeate based on molecular charge.

10. The centrifuge filter of claim 1 wherein the semipermeable material is selected for its ability to separate retentate from permeate based on ionic interactions therewith.

11. The centrifuge filter of claim 1 wherein the semipermeable material comprises a controlled pore-size membrane.

12. The centrifuge filter of claim 1 wherein the semipermeable material is chemically derivatized to bind selected chemical species having a specific desired interaction with chemical substances in the filtrate.
